(19) United States
(12) Patent Application Publication
(10) Pub. No.: US 2018/0041810 A1
(43) Pub. Date: Feb. 8, 2018

(54) SYSTEMS AND METHODS FOR CONTENT INFORMATION MESSAGE EXCHANGE

(71) Applicant: Sharp Kabushiki Kaisha, Sakai City, Osaka (JP)

(72) Inventors: Sachin G. DESHPANDE, Camas, WA (US); Peter T. MOSER, Camas, WA (US)

(21) Appl. No.: 15/556,357

(22) PCT Filed: Mar. 17, 2016
(86) PCT No.: PCT/JP2016/001558

§ 371 Date: Sep. 7, 2017

Related U.S. Application Data
(60) Provisional application No. 62/239,753, filed on Oct. 9, 2015.
(60) Provisional application No. 62/139,600, filed on Mar. 27, 2015.

(51) Int. Cl. H04N 21/482; H04N 21/4363

(52) U.S. Cl. CPC H04N 21/482; H04N 21/4363; H04H 60/72

(57) ABSTRACT

Message exchange techniques for content information communication between a primary device and a companion device are described. Example message exchange formats may include defined elements. Elements may be defined according an element name, a type, cardinality, a description, and a data type. In one example, an Extensible Markup Language (XML) based schema is defined for content identification information message. In one example, a JavaScript Object Notation (JSON) schema is defined for content identification information message.

### TECHNICAL FIELD

The present disclosure relates to the field of interactive television.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio) may originate from a plurality of sources including, for example, over-the-air television providers, satellite television providers, cable television providers, online media services, including, so-called streaming services, and the like. Digital media content may be transmitted from a source (e.g., an over-the-air television provider) to a receiver device (e.g., a digital television) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standard.

In addition to defining how digital media content may be transmitted from a source to a receiver device, transmission standards may define how data may be transmitted to support so-called second screen applications. Second screen applications may refer to applications operating on a device other than a primary receiver device. For example, it may be desirable for a tablet computer to run an application in conjunction with the media playback on the primary media rendering device, where the application enables an enhanced viewing experience. Current techniques for enabling second screen applications may be less than ideal.

### SUMMARY OF INVENTION

In general, this disclosure describes techniques for enabling second screen applications. In particular, this disclosure describes techniques for providing content information to a companion device. A companion device may refer to any device other than a primary device, where a primary device is configured to receive and process a transport stream. It should be noted that the term transport stream as used herein may refer specifically to an Internet Protocol (IP) based transport stream. In one embodiment it may refer to ISO Base Media File format (ISO BMFF) based transport stream. In other embodiment it may refer to Moving Pictures Expert Group (MPEG) transport stream, or the like, or may refer generally to any stream or container format including video, audio, and/or content data. Further, it should be noted that a companion device may include all or less than all of the capabilities of a primary device. For example, a companion device may or may not be configured to receive a transport stream. In another example, a companion device may have more or different capabilities compared to a primary device. It should be noted that primary device and companion device may be defined as logical roles. As such, a single physical device may act as both a primary device and/or a companion device at the same time or at different times. This disclosure describes techniques for enabling communications between a primary device and a companion device. In one example, a primary device may receive content information from a source and provide content information to a companion device. It should be noted that although in some examples the techniques of this disclosure are described with respect to ATSC standards, the techniques described herein are generally applicable to any transmission standard. For example, the techniques described herein are generally applicable to any of DVB standards, ISDB standards, Digital Terrestrial Multimedia Broadcast (DTMB) standards, Digital Multimedia Broadcast (DMB) standards, Hybrid Broadcast and Broadband (HbbTV) standard, World Wide Web Consortium (W3C) standards, and Universal Plug and Play (UPnP) standards. Further, the techniques described herein may be applicable to enabling second screen applications regardless of how digital multimedia is provided to a primary device. The techniques described herein may be particularly useful for enabling an enhanced viewing experience by enabling second screen applications that utilize content information. For example, the techniques described herein may be particularly useful for enabling an interactive electronic programming guide (EPG) to be presented to a user on a companion device.

According to one example of the disclosure, a method of transmitting content information comprises receiving content information from a source, generating a content information communication message based on received content information, and transmitting the content information communication message to a companion device.

According to another example of the disclosure, a device for transmitting content information comprises one or more processors configured to receive content information from a source, generate a content information communication message based on received content information, and transmit the content information communication message to a companion device.

According to another example of the disclosure, an apparatus for transmitting content information comprises means for receiving content information from a source, means for generating a content information communication message based on received content information, and means for transmitting the content information communication message to a companion device.

According to another example of the disclosure, a non-transitory computer-readable storage medium has instructions stored thereon that upon execution cause one or more processors of a device to receive content information from a source, generate a content information communication message based on received content information, and transmit the content information communication message to a companion device.

According to one example of the disclosure, a method for parsing content information comprises receiving a content information communication message, and parsing the content information communication message.

According to another example of the disclosure, a device for parsing content information comprises one or more processors configured to receive a content information communication message, and parse the content information communication message.

According to another example of the disclosure, an apparatus for parsing content information comprises means for receiving a content information communication message, and parsing the content information communication message.

According to another example of the disclosure, a non-transitory computer-readable storage medium has instructions stored thereon that upon execution cause one or more processors of a device to receive a content information communication message, and parse the content information communication message. In addition to parsing the content information communication message, some or all of the information from it may be displayed to the user, also the parsed information may be stored.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may implement one or more techniques of this disclosure.

FIG. 2 is a block diagram illustrating an example of a primary device that may implement one or more techniques of this disclosure.

FIG. 3 is a conceptual diagram illustrating an example structure of an example content information communication message.

FIG. 4 is a computer program listing illustrating an example schema of an example content information communication message.

FIG. 5 is a computer program listing illustrating an example content information communication message according to the example schema illustrated in FIG. 4.

FIG. 6 is a computer program listing illustrating an example schema of an example content information communication message.

FIG. 7 is a conceptual diagram illustrating an example structure of an example content information communication message.

FIG. 8 is a computer program listing illustrating an example schema of an example content information communication message.

FIG. 9A is a computer program listing illustrating an example schema of an example content information communication message.

FIG. 9B is a computer program listing illustrating an example schema of an example content information communication message.

FIG. 10 is a conceptual diagram illustrating an example structure of an example content information communication message.

FIG. 11 is a computer program listing illustrating an example schema of an example content information communication message.

FIG. 12 is a block diagram illustrating an example of a companion device that may implement one or more techniques of this disclosure.

FIG. 13 is a conceptual diagram illustrating an example communications flow between a primary device and a companion device.

FIG. 14 is a conceptual diagram illustrating an example communications flow between a primary device and a companion device.

FIG. 15 is a computer program listing illustrating an example schema of an example content information communication message.

### DESCRIPTION OF EMBODIMENTS

As described above, transmission standards may define how data may be provided to a companion device to support second screen applications. ATSC Candidate Standard: Interactive Services Standard (A/105:2014), S13-2-389r7, 12 Dec. 2013, Rev. 7, 24 Apr. 2014 (hereinafter “ATSC 2.0 A105”), specifies services that can be provided by a device configured to receive an ATSC 2.0 transport stream to support the display of content related to an audio and/or video (A/V) broadcast by applications running on second screen devices. According to ATSC 2.0 A105, an ATSC 2.0 receiver may support the following services for the use by a second screen application: trigger delivery service, two-way communications service, and optionally Hypertext Transport Protocol (HTTP) proxy server service. In ATSC 2.0 A105, trigger delivery service is limited to an ATSC 2.0 receiver simply passing triggers including limited information to a second screen device. The amount of information that may be included in a trigger is limited. Further, in ATSC 2.0 A105, two-way communications service simply provides a TCP/IP connection for a primary device (PD) and a second screen device to communicate. That is, each of the primary device and the second screen device must be configured to transmit and receive data according to a proprietary format. This typically results in devices that have different manufacturers being incompatible. In ATSC 2.0 A105, HTTP proxy server service simply provides a mechanism for a primary device to act as a proxy for a second screen device, e.g., when a second screen device has limited Internet connectivity. Thus, each of the services for supporting second screen applications in ATSC 2.0 A105 are limited and do not provide content information to an application running on a companion device in an efficient manner.

This disclosure describes message exchange formats for content information communication between a primary device (e.g., a digital television) and a companion device (e.g., a tablet computing device or a smartphone device). As described in detail below, the example message exchange formats described herein may include defined elements. Elements may be defined according an element name, a type (e.g., element or attribute), cardinality (i.e., allowed number of an element), a description, and a data type. Further, example semantics for parsing a content information communication message are described in detail below. In one example, an Extensible Markup Language (XML) based schema is defined for content identification information message. In one example, a JavaScript Object Notation (JSON) schema is defined for content identification information message. In another example, instead of JSON, JSONP (JSON with padding) data may be used. Variants are also described for the example schemas. Further, in other examples, data in other formats such as, for example, Comma Separated Values (CSV), Backus-Naur Form (BNF), Augmented Backus-Naur Form (ABNF), or Extended Backus-Naur Form (EBNF) may be used for content information communication.

Example message exchange flows for content information communication from a primary device to a companion device are described below. In one example, a companion device may receive content information according to a subscription mechanism described herein. In one example, a companion device may receive content information according to a request-response mechanism described herein. In one example, a WebSocket mechanism may be used for carrying content communication information messages between a primary device and a companion device. Additionally Hybrid broadcast broadband television (HbbTV) defined mechanisms (e.g. HbbTV 2.0 companion screen mechanisms) may be used for content information communication. In this case, in one example, the communication between a primary device and a companion device may be carried out as “application to application communication” as defined in HbbTV. In one example, a Universal Plug and Play (UPnP) Service may be defined for some or all of the content information message exchanges between a primary device and a companion device. This may allow any UPnP control point to discover the UPnP content information communication message service. In this case, the content information may be transmitted from a primary device to a companion device via a UPnP control mechanism and/or via a UPnP eventing mechanism. In another example, a Representational State Transfer (REST) mechanism may be used for exchanging content information messages between a primary device and a companion device. In this case, the content information may be transmitted from a primary device to a companion device via a HTTP GET mechanism and/or via a HTTP POST and/or via a HTTP PUT mechanism. In yet another example, Simple Object Access Protocol (SOAP) may be used for exchanging content information messages between a primary device and a companion device. In this manner, the example content information data formats described herein may be utilized with various message exchange flows.

Further, this disclosure describes techniques for providing content information to a companion device according to various content information formats. In one example, the Electronic Service Guide (ESG) data as defined in a service announcement or service guide of an ATSC standard or another telecommunications standard may be transmitted as a part of content information communication message. In one example, a subset of fragments (e.g., three of eleven) included in a defined service guide, for example, the Open Mobile Alliance (OMA) Mobile Broadcast Services Enabler Suite (BCAST) Service Guide Version 1.0.1, may be contained in elements and communicated from a primary device to a companion device. In another example, the HTTP response body may be used to send content information in a format, such as, for example XML, CSV, BNF, ABNF, or EBNF.

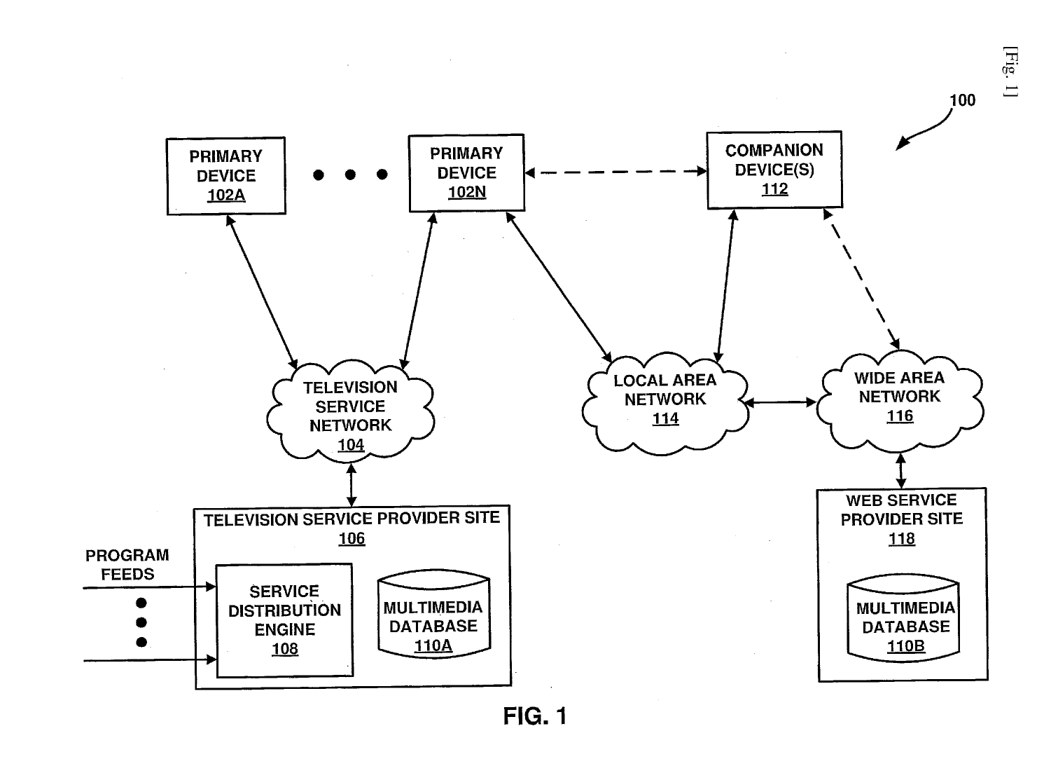

FIG. 1 is a block diagram illustrating an example of a system that may implement one or more techniques described in this disclosure. System 100 may be configured to provide content information to a companion device in accordance with the techniques described herein. In the example illustrated in FIG. 1, system 100 includes one or more primary devices 102A-102N, television service network 104, television service provider site 106, companion device(s) 112, local area network 114, wide area network 116, and web service provider site 118. In some examples the television service provider may be a broadcast service provider or broadcaster. System 100 may include software modules. Software modules may be stored in a memory and executed by a processor. System 100 may include one or more processors and a plurality of internal and/or external memory devices. Examples of memory devices include file servers, FTP servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to allow digital media content, such as, for example, television programming, to be distributed to and accessed by a plurality of computing devices, such as primary devices 102A-102N. In the example illustrated in FIG. 1, primary devices 102A-102N may include any device configured to receive a transport stream from television service provider site 106. For example, primary devices 102A-102N may be equipped for wired and/or wireless communications and may include televisions, including so-called smart televisions, set top boxes, and digital video recorders. Further, primary devices 102A-102N may include desktop, laptop, or tablet computers, gaming consoles, mobile devices, including, for example, “smart” phones, cellular telephones, and personal gaming devices configured to receive a transport stream from television service provider site 106. It should be noted that although example system 100 is illustrated as having distinct sites, such an illustration is for descriptive purposes and does not limit system 100 to a particular physical architecture. Functions of system 100 and sites included therein may be realized using any combination of hardware, firmware and/or software implementations.

Television service network 104 is an example of a network configured to enable television services to be provided. For example, television service network 104 may include public over-the-air television networks, public or subscription-based satellite television service provider networks, and public or subscription-based cable television provider networks and/or over-the-top (OTT) or Internet service providers. It should be noted that although in some examples television service network 104 may primarily be used to enable television services to be provided, television service network 104 may also enable other types of data and services to be provided according to any combination of the telecommunication protocols described herein. Television service network 104 may comprise any combination of wireless and/or wired communication media. Television service network 104 may include coaxial cables, fiber optic cables, twisted pair cables, wireless transmitters and receivers, routers, switches, repeaters, base stations, or any other equipment that may be useful to facilitate communications between various devices and sites. Television service network 104 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, Hybrid Broadcast and Broadband (HbbTV) standard, W3C standards, and Universal Plug and Play (UPnP) standards.

Referring again to FIG. 1, television service provider site 106 may be configured to distribute television service via television service network 104. For example, television service provider site 106 may include a public broadcast station, a cable television provider, or a satellite television provider. In the example illustrated in FIG. 1, television service provider site 106 includes service distribution engine 108 and multimedia database 110A. Service distribution engine 108 may be configured to receive a plurality of program feeds and distribute the feeds to primary devices 102A-102N through television service network 104. For example, service distribution engine 108 may include a broadcast station configured to transmit television broadcasts according to one or more of the transmission standards described above (e.g., an ATSC standard). Multimedia database 110A may include storage devices configured to store multimedia content. In some examples, television service provider site 106 may be configured to access stored multimedia content and distribute multimedia content to one or more of primary devices 102A-102N through television service network 104. For example, multimedia content (e.g., music, movies, and television (TV) shows) stored in multimedia database 110A may be provided to a user via television service network 104 on an on demand basis.

As illustrated in FIG. 1, in addition to being configured to receive a transport stream from television service provider site 106, a primary device 102A-102N may be configured to communicate with one or more companion device(s) 112 either directly or through local area network 114. Companion device(s) 112 may include a computing device configured to execute applications is conjunction with a primary device. It should be noted that in the example illustrated in FIG. 1, although a single companion device is illustrated, each primary device 102A-102N may be associated with one or more companion device(s). Companion device(s) 112 may be equipped for wired and/or wireless communications and may include devices, such as, for example, desktop, laptop, or tablet computers, mobile devices, smartphones, cellular telephones, and personal gaming devices. It should be noted that although not illustrated in FIG. 1, in some examples, companion device(s) may be configured to receive data from television service network 104.

In the example illustrated in FIG. 1, companion device(s) 112 may be configured to communicate directly with a primary device (e.g., using a short range communications protocol, e.g., Bluetooth), communicate with a primary device via a local area network (e.g., through a Wi-Fi router), and/or communicate with a wide area network (e.g., a cellular network). As described in detail below, a companion device may be configured to receive data, including content information, for use by an application running thereon.

Each of local area network 114 and wide area network 116 may comprise any combination of wireless and/or wired communication media. Each of local area network 114 and wide area network 116 may include coaxial cables, fiber optic cables, twisted pair cables, Ethernet cables, wireless transmitters and receivers, routers, switches, repeaters, base stations, or any other equipment that may be useful to facilitate communications between various devices and sites. Local area network 114 and wide area network 116 may be distinguished based on levels of access. For example, wide area network 116 may enable access to the World Wide Web. Local area network 114 may enable a user to access a subset of devices, e.g., computing devices located within a user's home. In some instances, local area network 114 may be referred to as a personal network or a home network.

Each of local area network 114 and wide area network 116 may be packet based networks and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of the IEEE 802 standards (e.g., Wi-Fi). In one example, a primary device and a companion device may communicate over local area network 114 using a local networking protocol, such as for example, a protocol based on the IEEE 802 standards.

Referring again to FIG. 1, web service provider site 118 may be configured to provide hypertext based content, and the like, to one or more of primary devices 102A-102N and/or companion device(s) 112 through wide area network 116. Web service provider site 118 may include one or more web servers. Hypertext content may be defined according to programming languages, such as, for example, Hypertext Markup Language (HTML), Dynamic HTML, XML, and data formats such as JSON. An example of a webpage content distribution site includes the United States Patent and Trademark Office website. Hypertext content may be utilized for second screen applications. For example, companion device(s) 112 may display a website in conjunction with television programming being presented on a primary device 102A-102N. It should be noted that hypertext based content and the like may include audio and video content. For example, in the example illustrated in FIG. 1, web service provider site 118 may be configured to access a multimedia database 110B and distribute multimedia content to one or more of primary devices 102A-102N and/or companion device(s) 112 through wide area network 116. In one example, web service provider site 118 may be configured to provide multimedia content using the Internet protocol suite. For example, web service provider site 118 may be configured to provide multimedia content to a primary device according to Real Time Streaming Protocol (RTSP). It should be noted that the techniques described herein may be applicable in the case where a primary device receives multimedia content and content information associated therewith from a web service provider site.

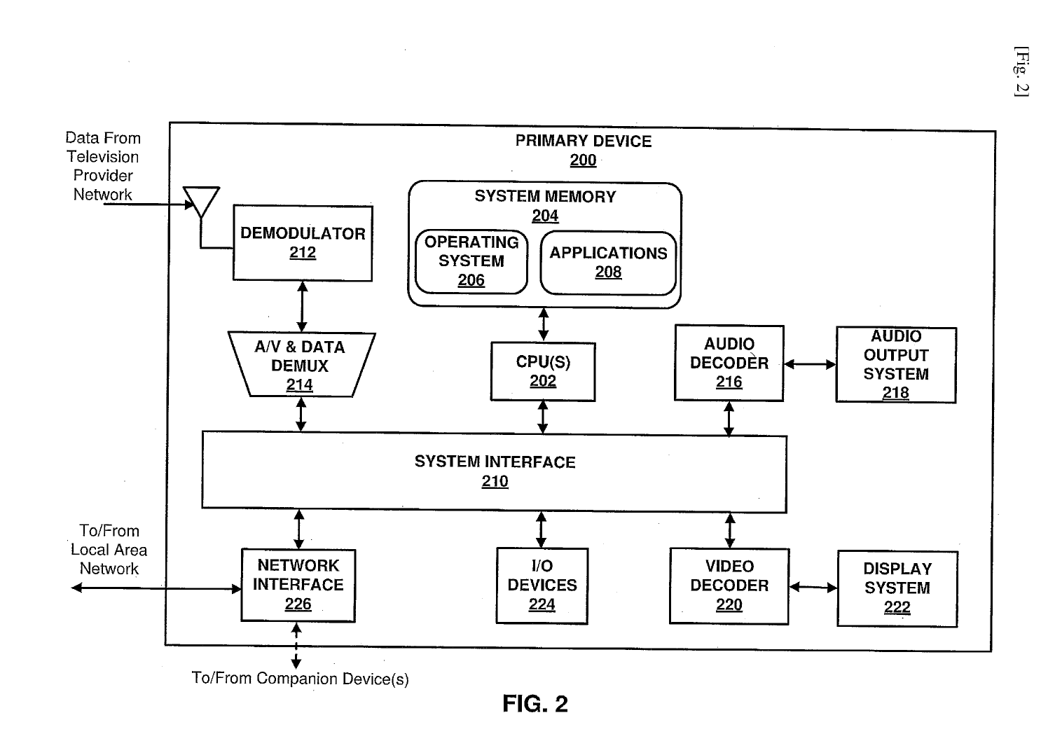

FIG. 2 is a block diagram illustrating an example of a primary device that may implement one or more techniques of this disclosure. Primary device 200 is an example of a computing device that may be configured to receive data from a communications network and allow a user to access multimedia content. In the example illustrated in FIG. 2, primary device 200 is configured to receive data via a television network, such as, for example, television service network 104 described above. Further, in the example illustrated in FIG. 2, primary device 200 is configured to send and receive data via a local area network and/or a wide area network. Primary device 200 may be configured to send data to and receive data from a companion device via a local area network or directly. It should be noted that in other examples, primary device 200 may be configured to simply receive data through a television service network 104 and send data to and/or receive data from (directly or indirectly) a companion device. The techniques described herein may be utilized by devices configured to communicate using any and all combinations of communications networks.

As illustrated in FIG. 2, primary device 200 includes central processing unit(s) 202, system memory 204, system interface 210, demodulator 212, A/V & data demux 214, audio decoder 216, audio output system 218, video decoder 220, display system 222, I/O devices 224, and network interface 226. As illustrated in FIG. 2, system memory 204 includes operating system 206 and applications 208. Each of central processing unit(s) 202, system memory 204, system interface 210, demodulator 212, A/V & data demux 214, audio decoder 216, audio output system 218, video decoder 220, display system 222, I/O devices 224, and network interface 226 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example primary device 200 is illustrated as having distinct functional blocks, such an illustration is for descriptive purposes and does not limit primary device 200 to a particular hardware architecture. Functions of primary device 200 may be realized using any combination of hardware, firmware and/or software implementations.

CPU(s) 202 may be configured to implement functionality and/or process instructions for execution in primary device 200. CPU(s) 202 may be capable of retrieving and processing instructions, code, and/or data structures for implementing one or more of the techniques described herein. Instructions may be stored on a computer readable medium, such as system memory 204 and/or other storage devices. CPU(s) 202 may include single and/or multi-core central processing units.

System memory 204 may be described as a non-transitory or tangible computer-readable storage medium. In some examples, system memory 204 may provide temporary and/or long-term storage. In some examples, system memory 204 or portions thereof may be described as non-volatile memory and in other examples portions of system memory 204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. System memory 204 may be configured to store information that may be used by primary device 200 during operation. System memory 204 may be used to store program instructions for execution by CPU(s) 202 and may be used by programs running on primary device 200 to temporarily store information during program execution. Further, in the example where primary device 200 is included as part of a digital video recorder, system memory 204 may be configured to store numerous video files.

Applications 208 may include applications implemented within or executed by primary device 200 and may be implemented or contained within, operable by, executed by, and/or be operatively/communicatively coupled to components of primary device 200. Applications 208 may include instructions that may cause CPU(s) 202 of primary device 200 to perform particular functions. Applications 208 may include algorithms which are expressed in computer programming statements, such as, for-loops, while-loops, if-statements, do-loops, etc. Applications 208 may be developed using a specified programming language. Examples of programming languages include, Java™, Jini™, C, C++, Objective C, Swift, Perl, Python, PhP, UNIX Shell, Visual Basic, and Visual Basic Script. In the example where primary devices 200 includes a smart television, applications may be developed by a television manufacturer or a broadcaster. As illustrated in FIG. 2, applications 208 may execute in conjunction with operating system 206. That is, operating system 206 may be configured to facilitate the interaction of applications 208 with CPUs(s) 202, and other hardware components of primary device 200. Operating system 206 may be an operating system designed to be installed on set-top boxes, digital video recorders, televisions, and the like. It should be noted that techniques described herein may be utilized by devices configured to operate using any and all combinations of software architectures. In one example, operating system 206 and/or applications 208 may be configured to generate content information messages in accordance with the techniques described in detail below.

System interface 210 may be configured to enable communications between components of computing device 200. In one example, system interface 210 comprises structures that enable data to be transferred from one peer device to another peer device or to a storage medium. For example, system interface 210 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, primary device 200 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 2, demodulator 212 and A/V & data demux 214 may be configured to extract video, audio, and data from a transport stream. A transport stream may be defined according to, for example, DVB standards, ATSC standards, ISDB standards, DTMB standards, DMB standards, and DOCSIS standards. It should be noted that although demodulator 212 and A/V & data demux 214 are illustrated as distinct functional blocks, the functions performed by demodulator 212 and A/V & data demux 214 may be highly integrated and realized using any combination of hardware, firmware and/or software implementations. Further, it should be noted that for the sake of brevity a complete description of digital radio frequency (RF) communications (e.g., analog tuning details, error correction schemes, etc.) is not provided herein. The techniques described herein are generally applicable to digital RF communications techniques used for transmitting digital media content and associated content information.

In one example, demodulator 212 may be configured to receive signals from an over-the-air signal and/or a coaxial cable and perform demodulation. Data may be modulated according a modulation scheme, for example, quadrature amplitude modulation (QAM), vestigial sideband modulation (VSB), or orthogonal frequency division modulation (OFDM). The result of demodulation may be a transport stream. A transport stream may be defined according to a telecommunications standard, including those described above. An IP based transport stream may include a single media stream or a plurality of media streams, where a media stream includes video, audio and/or data streams. Some streams may be formatted according to ISO base media file formats (ISOBMFF). An MPEG based transport stream may include a single program stream or a plurality of program streams, where a program stream includes video, audio and/or data elementary streams. In one example, a media stream or a program stream may correspond to a television program (e.g., a TV “channel”) or a multimedia stream (e.g., an on demand unicast). A/V & data demux 214 may be configured to receive transport streams and/or program streams and extract video packets, audio packets, and data packets. That is, AV & data demux 214 may apply demultiplexing techniques to separate video elementary streams, audio elementary streams, and data elementary streams for further processing by primary device 200.

Referring again to FIG. 2, packets may be processed by CPU(s) 202, audio decoder 216, and video decoder 220. Audio decoder 216 may be configured to receive and process audio packets. For example, audio decoder 216 may include a combination of hardware and software configured to implement aspects of an audio codec. That is, audio decoder 216 may be configured to receive audio packets and provide audio data to audio output system 218 for rendering. Audio data may be coded using multichannel formats such as those developed by Dolby and Digital Theater Systems. Audio data may be coded using an audio compression format. Examples of audio compression formats include MPEG formats, Advanced Audio Coding (AAC) formats, DTS-HD formats, and AC-3 formats. Audio output system 218 may be configured to render audio data. For example, audio output system 218 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 220 may be configured to receive and process video packets. For example, video decoder 220 may include a combination of hardware and software used to implement aspects of a video codec. In one example, video decoder 220 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 AVC), and High-Efficiency Video Coding (HEVC). Display system 222 may be configured to retrieve and process video data for display. For example, display system 222 may receive pixel data from video decoder 220 and output data for visual presentation. Further, display system 222 may be configured to output graphics in conjunction with video data, e.g., graphical user interfaces. Display system may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O devices 224 may be configured to receive input and provide output during operation of primary device 200. That is, I/O device 224 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 224 may be operatively coupled to computing device 200 using a standardized communication protocol, such as for example, Universal Serial Bus protocol (USB), Bluetooth, ZigBee or a proprietary communications protocol, such as, for example, a proprietary infrared communications protocol.

Network interface 226 may be configured to enable primary device 200 to send and receive data via a local area network and/or a wide area network. Further, network interface may be configured to enable primary device 200 to communicate with a companion device. Network interface 226 may include a network interface card, such as an Ethernet card, an optical transceiver, a radio frequency transceiver, or any other type of device configured to send and receive information. Network interface 226 may be configured to perform physical signaling, addressing, and channel access control according to the physical and Media Access Control (MAC) layers utilized in a network.

As described above, A/V & data demux 214 may be configured to extract data packets from a transport stream. Data packets may include content information. In another example, network interface 226 and in turn system interface 210 may extract the data packets. In this example the data packets may originate from a network, such as, local area network 114 and/or wide area network 116. As used herein, the term content information may refer generally to any information associated with services received via a network. Further, the term content information may refer more specifically to information associated with specific multimedia content. Data structures for content information may be defined according to a telecommunications standard. For example, ATSC standards describe Program and System Information Protocol (PSIP) tables which include content information. Types of PSIP tables include Event Information Tables (EIT), Extended Text Tables (ETT) and Data Event Tables (DET). In ATSC standards, DETs and EITs may provide event descriptions, start times, and durations. In ATSC standards, ETTs may include text describing virtual channels and events. Further, in a similar manner to ATSC, DVB standards include Service Description Tables, describing services in a network and providing the service provider name, and EITs including event names descriptions, start times, and durations. Primary device 200 may be configured to use these tables to display content information to a user (e.g., present an EPG).

In addition to or as an alternative to extracting tables from a transport stream to retrieve content information, as described above, primary device 200 may be configured to retrieve content information using alternative techniques. For example, ATSC 2.0 defines Non-Real-Time (NRT) delivery techniques. NRT techniques may enable a primary device to receive content information via a file delivery protocol (e.g., File Delivery over Unidirectional Transport (FLUTE) and/or via the Internet (e.g., using HTTP). Content information transmitted to a primary device according to NRTC may be formatted according to several data formats. One example format includes the data format defined in OMA BCAST Service Guide Version 1.0.1. In a similar manner, DVB standards define ESG techniques which may be used for transmitting content information. Service guides may provide information about current and future service and/or content. Primary device 200 may be configured to receive content information according to NRT techniques and/or ESG techniques. That is, primary device 200 may be configured to receive a service guide. In should be noted that the techniques described herein may generally be applicable regardless of how a primary device receives content information.

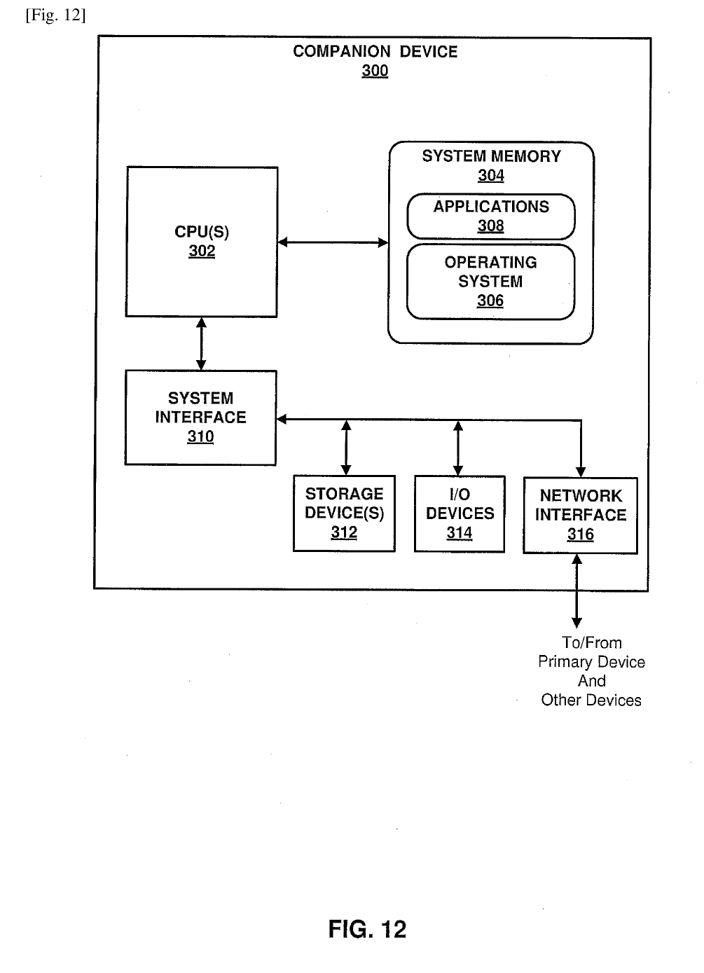

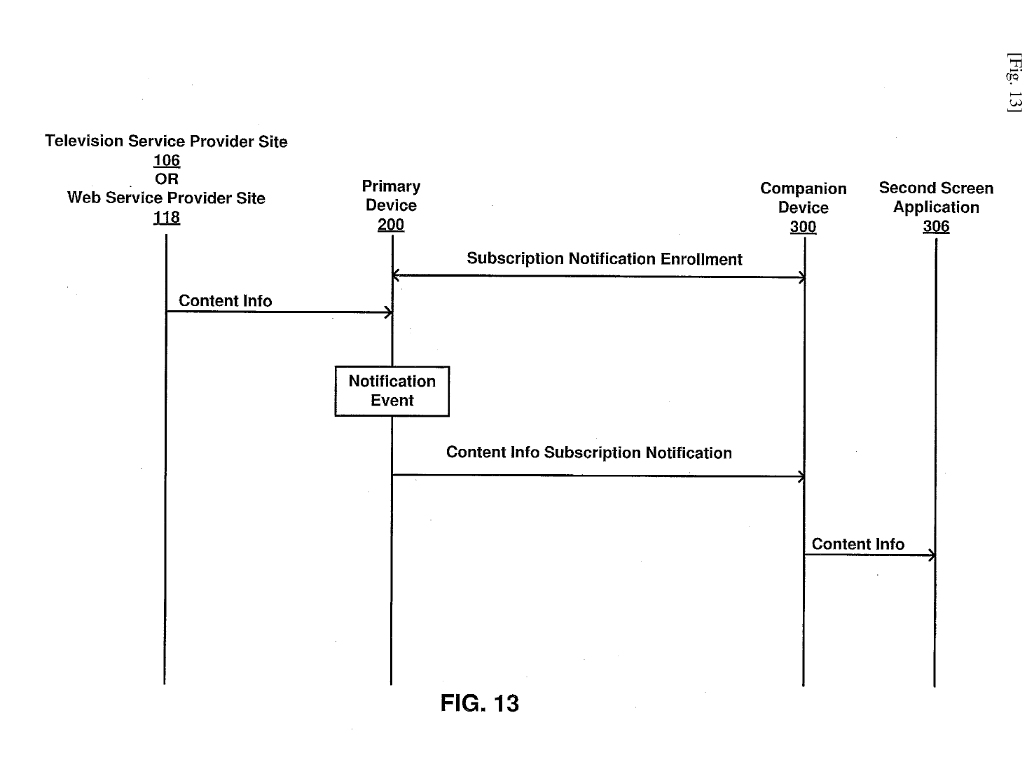

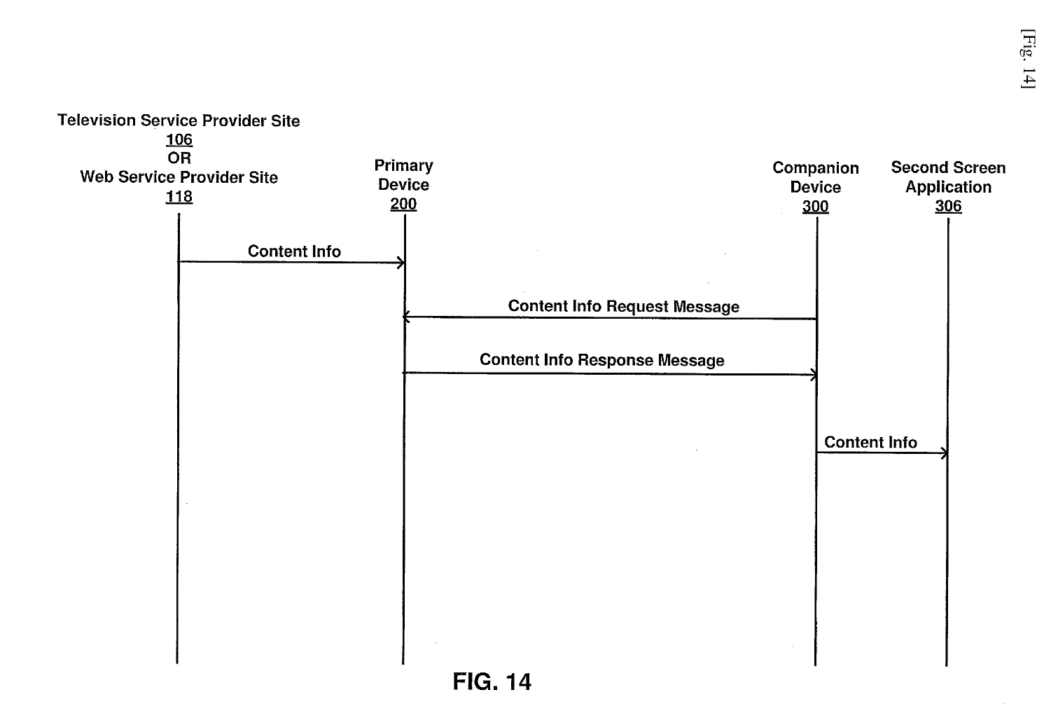

As described above, primary device 200 may be configured to send data to and receive data from a companion device via a local area network or directly. Further, primary device 200 may be configured to send data to and receive data from a companion device according to one or more communication techniques, e.g., defined communication flows. An example of a companion device is described below with respect to FIG. 12. Further, examples of communication flows between a primary device and a companion device are described below with respect to FIG. 13 and FIG. 14.

In one example, primary device 200 may be configured to send content information to a companion device according to a content information communication message. A content information communication message may include elements and optionally attributes. It should be noted that in some cases the distinction between an element and an attribute may be arbitrary, depending on the application. In some instances, a content information communication message may be referred to as a content identification communication message. Table 1 provides examples of elements that may be used to compose a content information communication message.

TABLE 1

| | Type | | | |
|---|---|---|---|---|
| | (E = | | | |
| | element or | | | |
| | A = | | | |
| Element Name | attribute) | Cardinality | Description | Data Type |
| serviceID | E | 1 | The service ID for currently | string |
| | | | running service | |
| | | | In one example the service ID | |
| | | | may include information about | |
| | | | a major channel number and | |
| | | | minor channel number for the | |
| | | | service. | |
| programID | E | 1 | The program ID. A Program is a | string |
| | | | temporal segment of a service/ | |
| | | | channel. | |
| showID | E | 1 | The show ID. Show is a playout | string |
| | | | of a program. | |
| segmentID | E | 1 . . . N | The segment ID. A show | string |
| | | | consists of one or more show | |
| | | | segments. | |
| | | | Contains following attributes | |
| | | | cTime | |
| | | | sType | |
| cTime | A | 1 | current time location within the | dateTime |
| | | | segment. | |
| sType | A | 0 . . . 1 | Segment type | unsignedByte |
| | | | Value of 0 indicates show | |
| | | | segment | |
| | | | Value of 1 indicates interstitial | |
| | | | segment (e.g., commercial) | |
| | | | Values 2-255 are reserved | |
| Name | E | 1 . . . N | Name of the show possibly in | string |
| | | | multiple languages. The | |
| | | | language is expressed using | |
| | | | built-in XML attribute | |
| | | | ‘xml:lang’ with this element. | |
| Description | E | 0 . . . N | Description, possibly in | string |
| | | | multiple languages. The | |
| | | | language is expressed using | |
| | | | built-in XML attribute | |
| | | | ‘xml:lang’ with this element. | |
| CARatings | E | 1 | Content advisory ratings | string |
| | | | (parental ratings) for the show | |
| | | | or content. | |
| | | | In another example instead of a | |
| | | | string data type multiple | |
| | | | elements, sub-elements and | |
| | | | attributes may be used to | |
| | | | represent the CARatings | |
| | | | element. In one example, the | |
| | | | content advisory rating is | |
| | | | indicated for each rating region. | |
| | | | For each rating region rating | |
| | | | value is provided for one or | |
| | | | more rating dimensions. | |
| Components | E | 0 . . . N | Individual content components | |
| | | | within the show/content. | |
| | | | Contains the following | |
| | | | attributes | |
| | | | CARatings | |
| | | | componentType | |
| | | | componentRole | |
| | | | componentName | |
| | | | componentID | |
| | | | componentURL | |
| | | | componentdeviceCapabilities | |
| CARatings | E | 0 . . . 1 | Content advisory ratings | string |
| | | | (parental ratings) for the | |
| | | | component. | |
| | | | In another example instead of a | |
| | | | string data type multiple | |
| | | | elements, sub-elements and | |
| | | | attributes may be used to | |
| | | | represent the CARatings | |
| | | | element. In one example, for | |
| | | | each component the content | |
| | | | advisory rating is indicated for | |
| | | | each rating region. For each | |
| | | | rating region rating value is | |
| | | | provided for one or more rating | |
| | | | dimensions. | |
| componentType | A | 1 | Type of the component (e.g. | unsignedByte |
| | | | audio, video, closed caption, | |
| | | | etc.) | |
| | | | Value of 0 indicates an audio | |
| | | | component | |
| | | | Value of 1 indicates a video | |
| | | | component | |
| | | | Value of 2 indicated a closed | |
| | | | caption component | |
| | | | Value of 3 indicates an | |
| | | | application component | |
| | | | Value of 4 indicates a | |
| | | | metadata component | |
| | | | Values 5 to 255 are reserved | |
| componentRole | A | 1 | Role or kind of the component, | unsignedByte |
| | | | In one example the | |
| | | | componentRole may be defined | |
| | | | as follows: | |
| | | | For audio (when | |
| | | | componentType attribute | |
| | | | above is equal to 0): | |
| | | | values of componentRole | |
| | | | attribute are as follows: | |
| | | | 0 = Complete main, | |
| | | | 1 = Music and Effects, | |
| | | | 2 = Dialog, | |
| | | | 3 = Commentary, | |
| | | | 4 = Visually Impaired, | |
| | | | 5 = Hearing Impaired, | |
| | | | 6 = Voice-Over, | |
| | | | 7-254 = reserved, | |
| | | | 255 = unknown. | |
| | | | For Video (when | |
| | | | componentType attribute | |
| | | | above is equal to 1) values of | |
| | | | componentRole attribute are | |
| | | | as follows: | |
| | | | 0 = Primary video, | |
| | | | 1 = Alternative camera view, | |
| | | | 2 = Other alternative video | |
| | | | component, | |
| | | | 3 = Sign language inset, | |
| | | | 4 = Follow subject video, | |
| | | | 5 = 3D video left view, | |
| | | | 6 = 3D video right view, | |
| | | | 7 = 3D video depth | |
| | | | information, | |
| | | | 8 = Part of video array <x, y> | |
| | | | of <n, m>, | |
| | | | 9 = Follow-Subject metadata, | |
| | | | 10-254 = reserved, | |
| | | | 255 = unknown. | |
| | | | For Closed Caption | |
| | | | component (when | |
| | | | componentType attribute | |
| | | | above is equal to 2) values of | |
| | | | componentRole attribute are | |
| | | | as follows: | |
| | | | 0 = Normal, | |
| | | | 1 = Easy reader, | |
| | | | 2-254 = reserved, | |
| | | | 255 = unknown. | |
| | | | When componentType | |
| | | | attribute above is between 5 to | |
| | | | 255, inclusive, the | |
| | | | componentRole shall be equal | |
| | | | to 255. | |
| componentName | A | 0 . . . 1 | Human readable name of the | string |
| | | | component | |
| @componentID | A | 1 | Component identifier | string |
| componentURL | A | 1 . . . N | Uniform resource locator | anyURI |
| | | | address to access the component | |
| NRTContentItems | E | 0 . . . N | Non real-time content items | |
| | | | (files, data elements) available | |
| | | | for the show/content. | |
| | | | Contains the following elements | |
| | | | NRTItemLocation | |
| | | | NRTItemID | |
| | | | NRTItemname | |
| | | | NRTcontentType | |
| | | | NRTcontentEncoding | |
| NRTItemLocation | A | 1 | Uniform resource locator | anyURI |
| | | | address/other location | |
| | | | information to access the NRT | |
| | | | file or data. | |
| NRTItemID | A | 1 | Non real-time item's (file/data) | string |
| | | | identifier | |
| NRTItemName | A | 1 | Non real-time item's (file/data) | string |
| | | | name | |
| NRTContentType | A | 1 | Non real-time item's (file/data) | string |
| | | | content-type. Obeys the | |
| | | | semantics of Content-Type | |
| | | | header of HTTP/1.1 protocol | |
| | | | RFC 2616. | |
| NRTContentEncoding | A | 1 | Non real-time item's (file/data) | string |
| | | | content-encoding. Obeys the | |
| | | | semantics of Content-Encoding | |
| | | | header of HTTP/1.1 protocol | |
| | | | Request for Comments (RFC) | |
| | | | 2616 | |

As illustrated in Table 1, elements in content information communication message may be classified as identifying elements (i.e., serviceID, programID, showID, segementID, cTime, sType, Name, Description, and CARatings), content component elements (i.e., CARatings, componentType, componentRole, componentName, componentID, componentURL, and componentdeviceCapabilities), and non real-time content element for a show (NRTItemLocation, NRTItemID, NRTItemname, NRTcontentType, NRTcontentEncoding). Although Table 1 shows the data type for componentRole as unsignedByte in another example the data type for componentRole may be string. In that case the various componentRole values may be encoded as strings. With respect to Table 1, Cardinality with a value of x . . . y means the number of the presented instances of this element or attribute is in the range from x to y, inclusive. Further, with respect to Table 1, Data Type indicates a particular kind of data item, as defined by the range of allowed values. Further, with respect to Table 1, Type indicates if a particular element or attribute is an element or if it is an attribute. As described in further detail below, a companion device may be configured to use one or more of the elements described in Table 1 for use with a second screen application. For example, a second screen application may be configured to use identifying elements to identify/verify content that is currently being rendered by a primary device. Further, a second screen application may be configured to use component information to provide an enhanced/alternative presentation of content. For example, a second screen application may use component information to provide an alternative rendering of content. For example, when a primary device is rendering a primary audio track of a television program, a second screen application may be configured to use component elements to retrieve (e.g., using a componentURL) and render a secondary audio track (e.g., commentary, alternative language, etc.). Further, a second screen application may be configured to use non real-time content elements to provide an enhanced/alternative presentation of content. For example, a second screen application may use a NRTItemLocation to retrieve a coupon associated with an advertisement being rendered on a primary device.

In some instances, it may be useful for a second screen application to have information regarding the capabilities of a primary device. For example, a second screen application may be configured to render an enhancement based on the capabilities of a primary device. Table 2 provides examples of device elements that may be additionally used to compose a content information communication message. As illustrated in Table 2, the elements therein may identify a primary device and a version (e.g., a firmware version or application version) associated with a primary device.

TABLE 2

| | Type | | | |
|---|---|---|---|---|
| | (E = | | | |
| | element or | | | |
| Element | A = | | | Data |
| Name | attribute) | Cardinality | Description | Type |
| PDDevID | E | 0 . . . 1 | Device identifier for the | string |
| | | | primary device | |
| PDVersion | E | 0 . . . 1 | Version for primary | string |
| | | | device | |

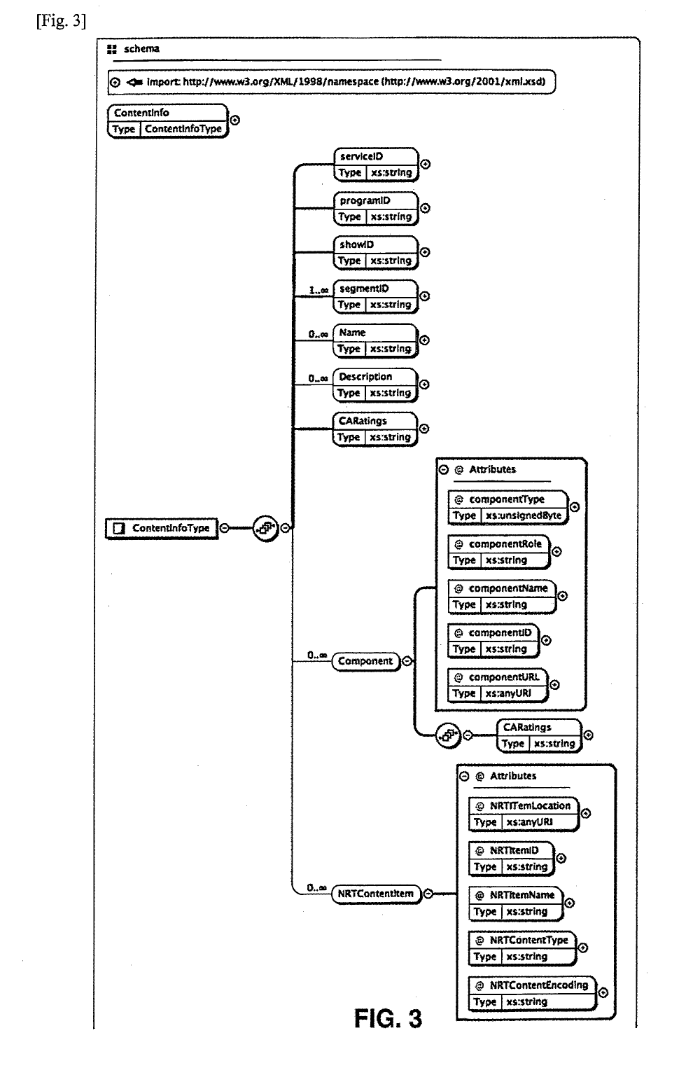

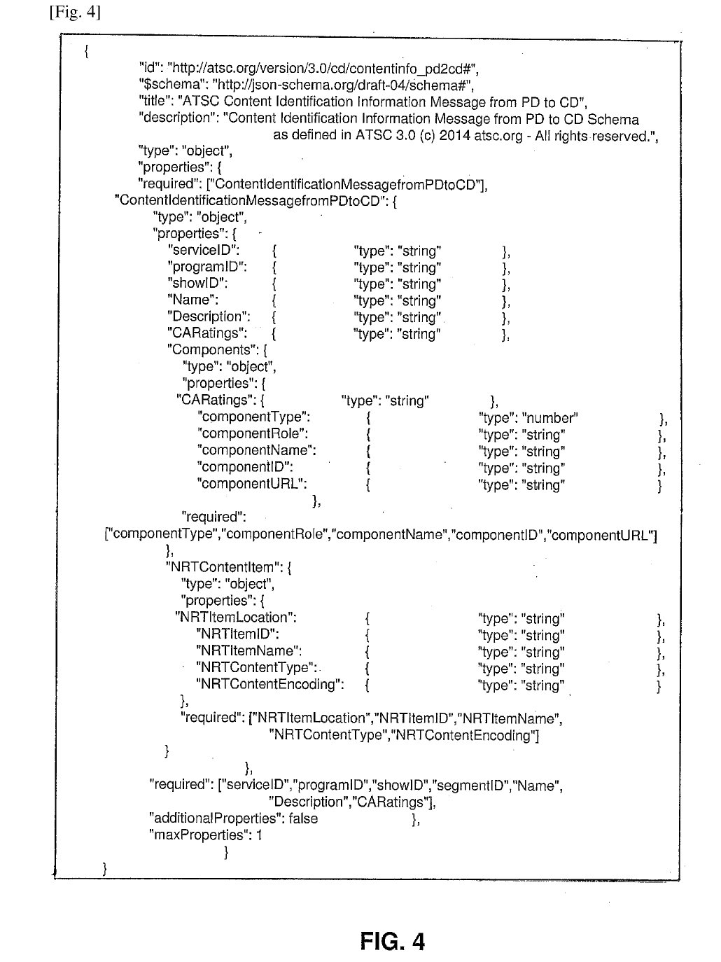

Referring again to Table 1, each of the elements may be included in a content information message according to a defined structure. FIG. 3 is a conceptual diagram illustrating an example structure of an example content information communication message. Primary device 200 may use a structure to create a content information communication message according to a schema, where a schema may include a description of a file or document. FIG. 4 is a computer program listing illustrating an example schema of an example content information communication message according to JSON.

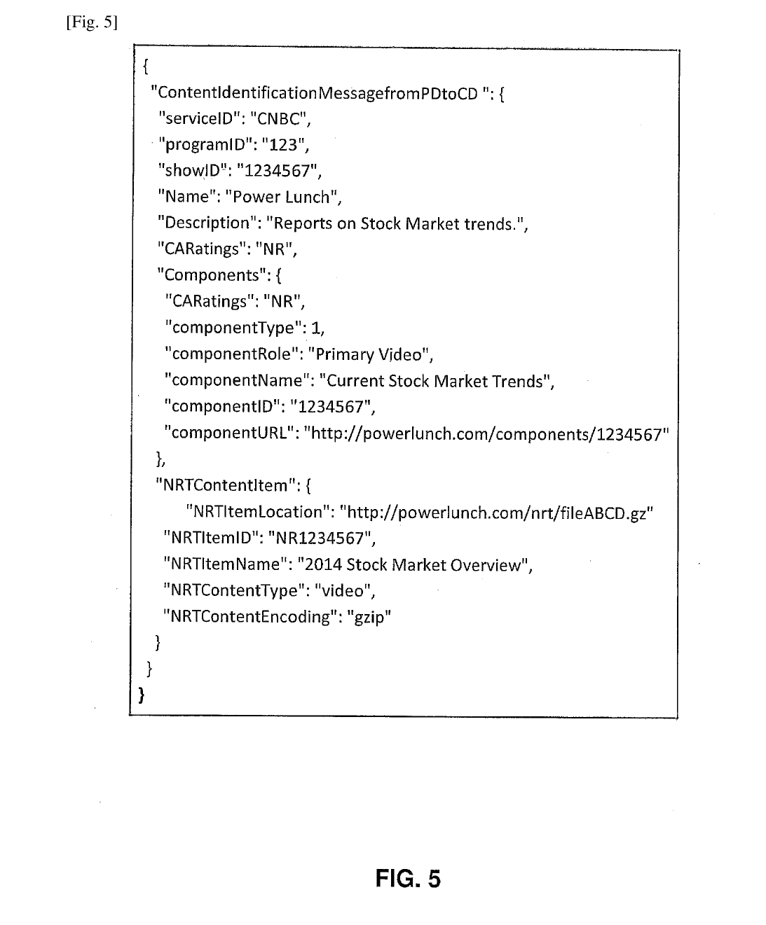

FIG. 5 is a computer program listing illustrating an example content information communication message according to the example schema illustrated in FIG. 4. As illustrated in FIG. 5, the television program (i.e., “Name” value of “Power Lunch”) may be associated with enhanced content. That is, as illustrated in FIG. 5, a video component (i.e., “componentName” value of “Current Stock Market Trends”) may be available at the componentURL and a video (i.e., “NRTItemName” of “2014 Stock Market Overview,”) may be available at NRTItemLocation. In this manner, a companion device receiving the information communication message illustrated in FIG. 5 may render either of the videos in conjunction with a primary device rendering the main program.

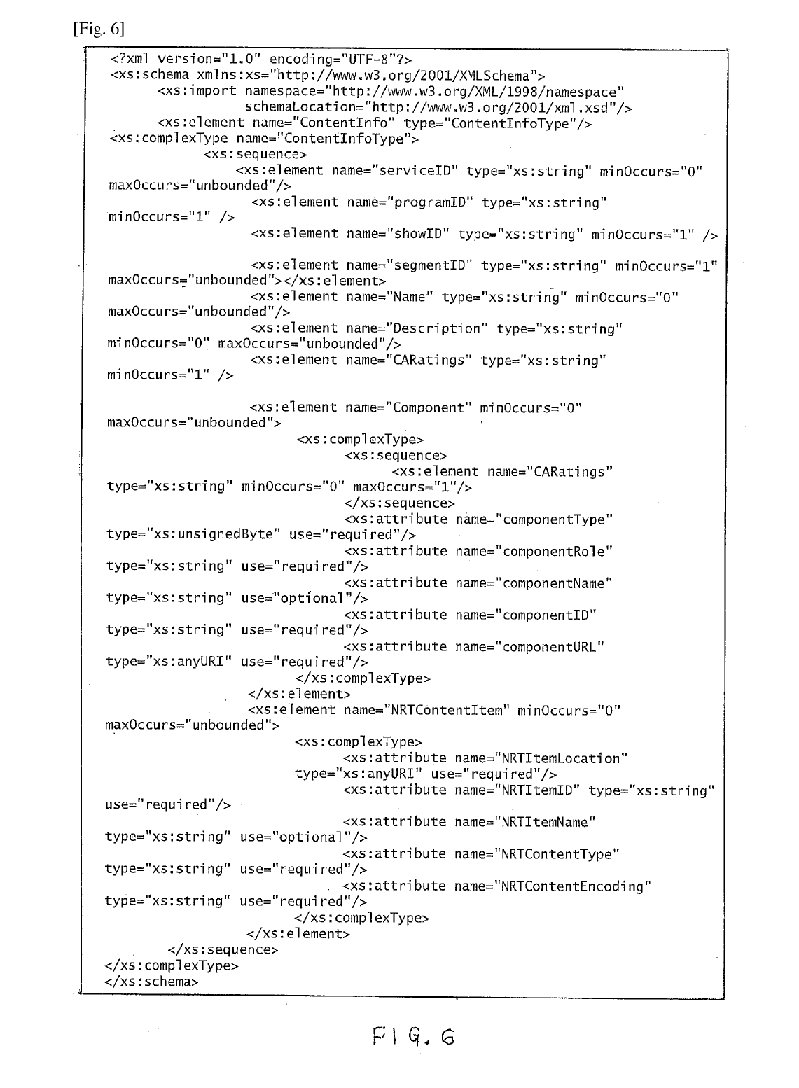

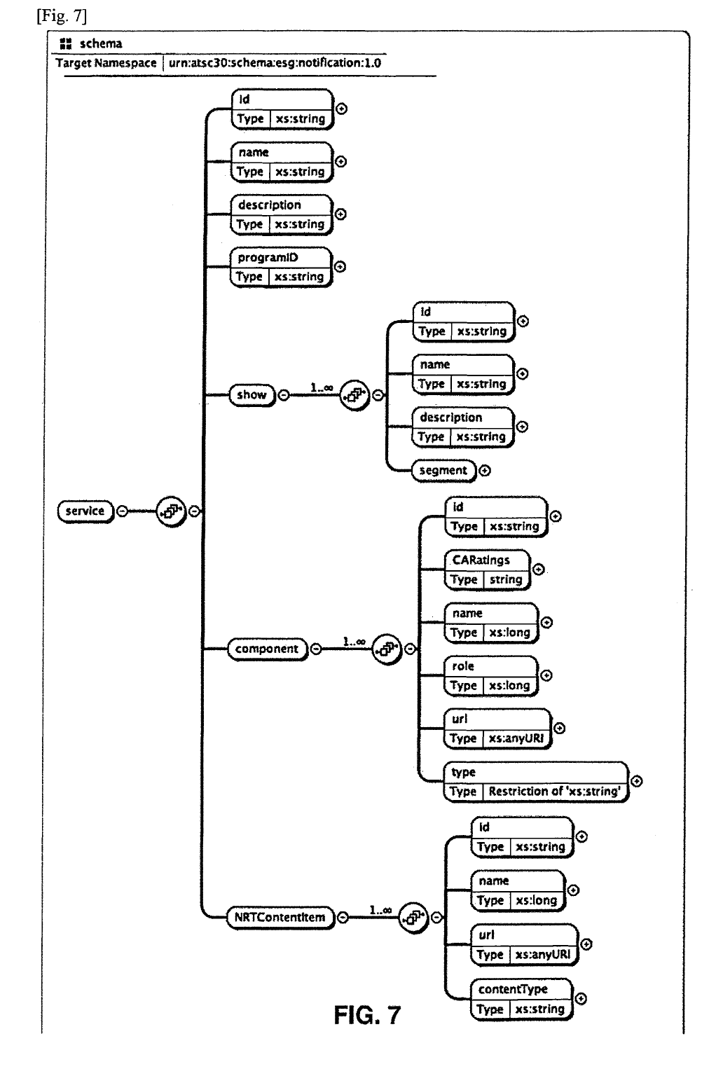

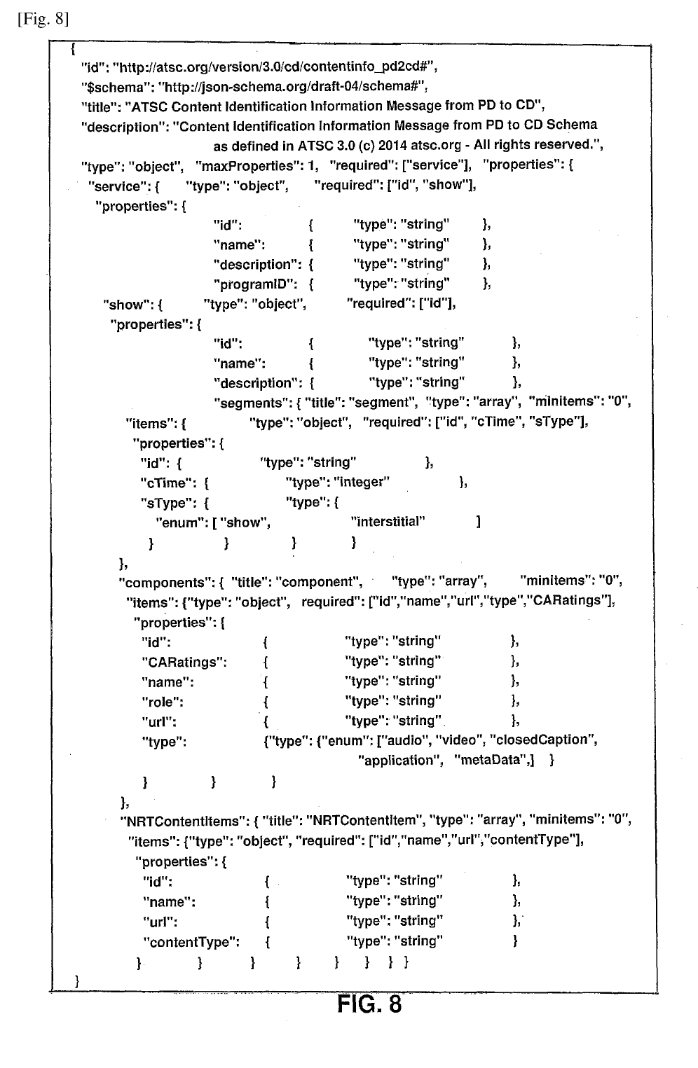

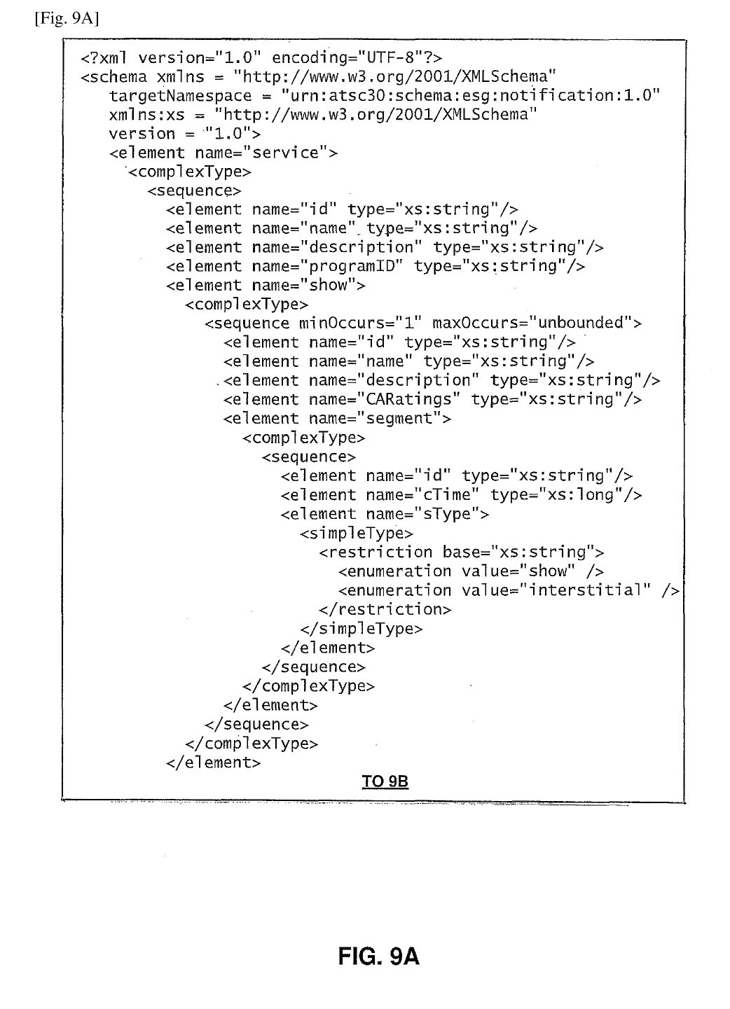

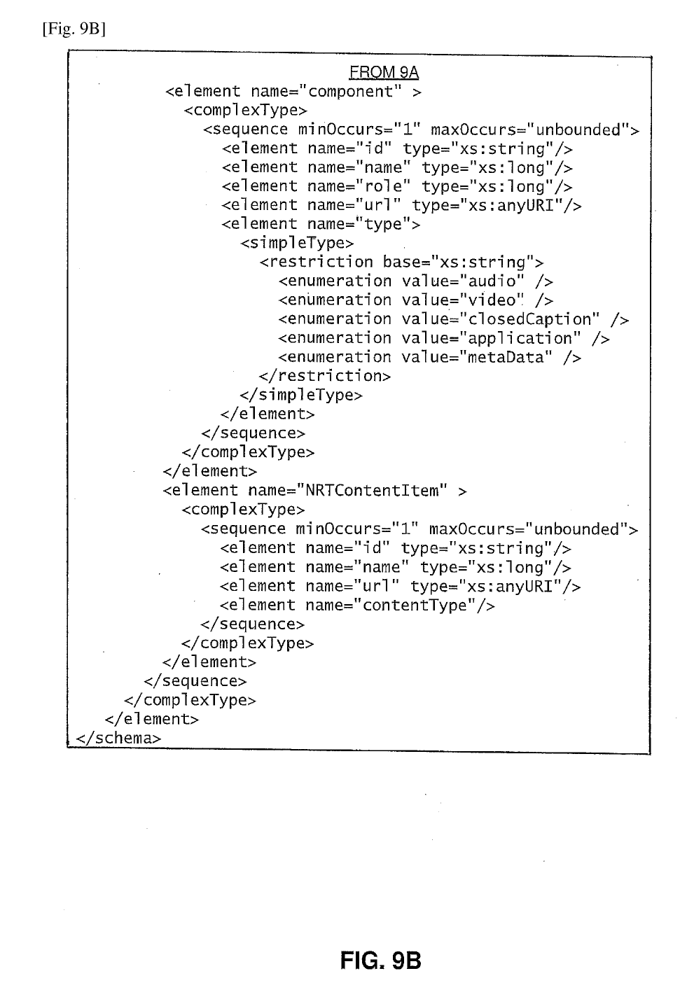

In addition to or as an alternative to using a JSON schema for a content information communication message, primary device 200 may be configured to generate a content information message using another type of schema. FIG. 6 is computer program listing illustrating an example schema of an example content information communication message according to XML. Further, in addition to or as an alternative to formatting a content information communication message according to the structure illustrated in FIG. 3, primary device 200 may be configured to format a content information communication according to another structure. FIG. 7 is a conceptual diagram illustrating an example structure of an example content information communication message. It should be noted that the structure illustrated in FIG. 7, includes component values as elements, instead of attributes as illustrated in the example of FIG. 3 and TABLE 1. This may allow a companion device to logically nest some elements as sub-elements of other elements, thus making it easier to parse. FIG. 8 is a computer program listing illustrating an example schema of an example content information communication message according to JSON based on the structure illustrated in FIG. 7. FIGS. 9A-9B is a computer program listing illustrating an example schema of an example content information communication message according to XML based on the structure illustrated in FIG. 7.

As described above, primary device 200 may be configured to receive content information according to NRT techniques and/or ESG techniques. In one example, primary device 200 may use NRT and/or ESG data included in a service announcement, or the like, as a part of content information communication message. The OMA BCAST Service Guide Version 1.0.1 defines fragments of data, where a fragment of data corresponds to a separate well-formed XML document. OMA BCAST Service Guide Version 1.0.1 includes the following defined fragments: Service, Schedule, Content, Access, SessionDescription, PurchaseItem, PurchaseDate, PurchaseChannel, PreviewData, InteractivityData, and ServiceGuideDeliveryDescriptor. In one example, primary device 200 may form a content information communication message by respectively encapsulating one or more fragments. It should be noted that in this case, a content information communication message may be referred to as an ESG information message.

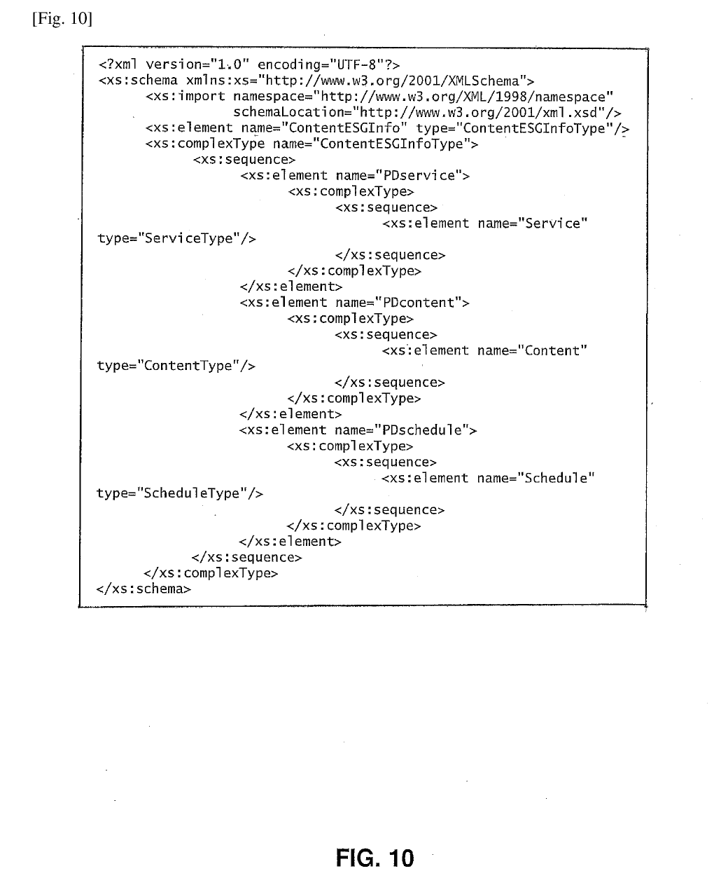

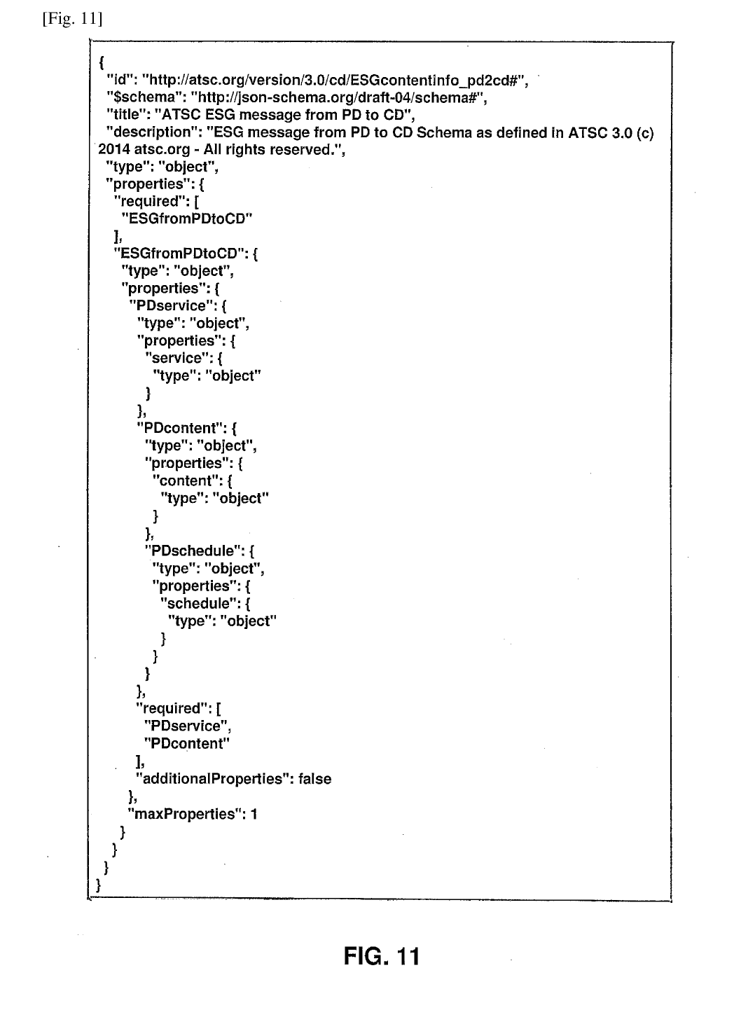

In one example, primary device 200 may be configured to form a content information communication message by respectively encapsulating one or more of Service, Schedule, and Content fragments. As described in OMA BCAST Service Guide Version 1.0.1, the Service fragment describes at an aggregate level the content items which comprise a broadcast service, the Schedule fragment defines the timeframes in which associated content items are available for streaming, downloading and/or rendering, and the Content fragment gives a detailed description of a specific content item. Table 3 provides an example of elements that may respectively correspond to each of a Service fragment, a Schedule fragment, and a Content fragment of service guide. As illustrated in Table 3, a PDservice element may encapsulate a Service fragment, a PDcontent element may encapsulate a Content fragment, and a PDschedule element may encapsulate a Schedule fragment. In a manner similar to that described above with respect to Table 1, primary device 200 may create a content information communication message using elements included in Table 3 according to a schema. FIG. 10 is a computer program listing illustrating an example schema of an example content information communication message including the elements defined in Table 3 according to XML. FIG. 11 is a computer program listing illustrating an example schema of an example content information communication message including the elements defined in Table 3 according to JSON.

TABLE 3

| | Type | | | |
|---|---|---|---|---|
| | (E = | | | |
| | element or | | | |
| Element | A = | | | |
| Name | attribute) | Cardinality | Description | Data Type |
| PDservice | E | 0 . . . N | Container for Service fragment | container |
| | | | data of ATSC 3.0/OMA BCAST | element |
| | | | service guide. | |
| | | | Contains the following element: | |
| | | | Service | |
| PDcontent | E | 0 . . . N | Container for Content fragment | container |
| | | | data of ATSC 3.0/OMA BCAST | element |
| | | | service guide. | |
| | | | Contains the following element: | |
| | | | Content | |
| PDschedule | E | 0 . . . N | Container for Schedule fragment | container |
| | | | data of ATSC 3.0/OMA BCAST | element |
| | | | service guide. | |
| | | | Contains the following element: | |
| | | | Schedule | |

A companion device may be configured to use one or more of the elements described in Table 3 for use with a second screen application. For example, a second screen application may be configured to use one or more of PDservice element, a PDcontent element, and a PDschedule element to provide an enhanced/alternative presentation of content. For example, a second screen application may use a PDcontent element to provide an alternative rendering of content. In addition or as an alternative to formatting the content information communications messages according to the example schemas described above, primary device may be configured to format a content information communication message based on one or more other formats, including, for example, CSV, BNF, ABNF, or EBNF.

In another example primary device 200 may be configured to simply transmit a Service fragment, a Schedule fragment, and a Content fragment of service guide without further encapsulation of each fragment. In one case then the entire structure may still be encapsulated within a PDESG element which may be described as shown in Table 4.

TABLE 4

| | Type | | | |
|---|---|---|---|---|
| | (E = | | | |
| | element or | | | |
| Element | A = | | | |
| Name | attribute) | Cardinality | Description | Data Type |
| PDServiceGuideData | E | 1 | Container for a sequenc of one or | container |
| | | | more Service, content, schedule | element |
| | | | fragment data of ATSC 3.0/ | |
| | | | OMA BCAST service guide. | |
| | | | Contains the following ATSC | |
| | | | 3.0/OMA BCAST service guide | |
| | | | fragments: | |
| | | | Service | |
| | | | Content | |
| | | | Schedule | |

In another example, a companion device (e.g., companion device 300) may send a request to primary device 200 to receive full or partial ESG information. In one example, the request may be a Uniform Resource Identifier (URI) request. In one example, the request may be a Universal Resource Locator (URL) request. In one example, the URL request may be based on the following example URL:

http://<PD Host URL>/atsc3.csservices.esg.2?<Query>

An example of a URL query parameter, <Query>, is illustrated in Table 5. As illustrated in TABLE 5, in one example there may be three types of query parameters, e.g., a request for ESG information for a current show, a request for ESG information for a current service, and a request for all ESG information for all available services. Further, in the example URL above, “atsc3.csservices.esg.2” may refer to name of the service and <PD Host URL> may refer to the URL on the host primary device.

TABLE 5

| Query Parameter | Description |
|---|---|
| ESGRequesttype = 0 | Request for ESG information for the current show only |
| | It consists of the Service, Schedule and Content fragments (as defined in ATSC 3.0/ |
| | OMA BCAST service guide) of the current show. |
| ESGRequesttype = 1 | Request for ESG information for the current service only |
| | It consists of the Service, Schedule and Content fragments (as defined in ATSC 3.0/ |
| | OMA BCAST service guide) of the current virtual channel. |
| ESGRequesttype = 2 | Request for all ESG information for all available services |
| | It consists of the Service, Schedule and Content fragments (as defined in ATSC 3.0/ |
| | OMA BCAST service guide) of the all virtual channels of which their ESG are |
| | available to be transferred. |

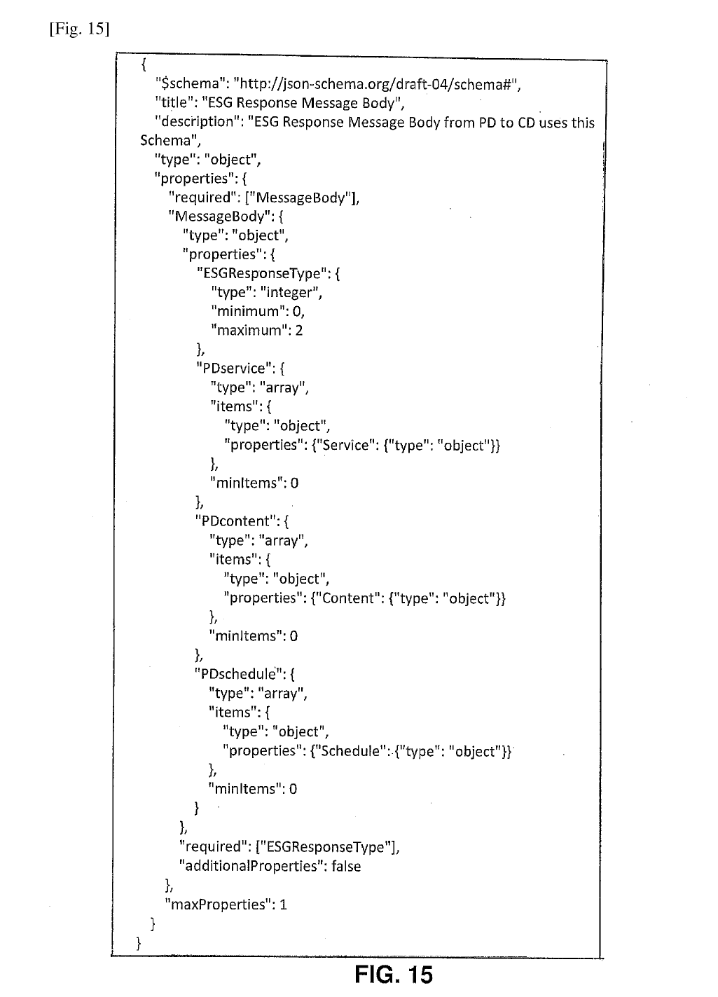

In one example, primary device 200 may send an ESG service response message including example elements illustrated in TABLE 6. FIG. 15 is a computer program listing illustrating an example schema of an example content information communication message including the example elements defined in Table 6. In the example illustrated in FIG. 15 the example message is formatted according to JSON.

TABLE 6

| Element Name | Cardinality | Description |
|---|---|---|
| MessageBody | 1 | Message body data. |
| ESGResponseType | 1 | ESGResponseType equal to 0 indicates that ESG |
| | | information for only the current show is included in |
| | | the response. ESGResponseType equal to 1 |
| | | indicates that ESG information for only the current |
| | | service is included in the response. |
| | | ESGResponseType equal to 2 indicates that all |
| | | ESG information for all the services is included in |
| | | the response. |
| PDService | 0 . . . N | Container for Service fragment and its |
| | | sub-elements as defined in ATSC 3.0/OMA BCAST |
| | | service guide. Contains the following element: |
| | | Service |
| PDSchedule | 0 . . . N | Container for Schedule fragment and its |
| | | sub-elements as defined in in ATSC 3.0/OMA |
| | | BCAST service guide. Contains the following |
| | | element: |
| | | Schedule |
| PDContent | 0 . . . N | Container for Content fragment and its |
| | | sub-elements as defined in in ATSC 3.0/OMA |
| | | BCAST service guide. Contains the following |
| | | element: |
| | | Content |

In should be noted that in the example illustrated TABLE 6, when ESGRequesttype=0 or ESGRequesttype=1 but the primary device is not able to transfer the ESG of the current show segment or channel, the MessageBody element may be transferred with no sub-elements. When ESGRequesttype=2, the primary device may transfer ESGs of channels having ESGs that are available to be transferred or the primary device may respond back with a lower value for ESGResponseType than requested in the ESGRequestType and its associated ESG information.

As described above, primary device 200 may be configured to send data to and receive data from a companion device according to one or more communication techniques. FIG. 12 is a block diagram illustrating an example of a companion device that may implement one or more techniques of this disclosure. Companion device 300 may include one or more processors and a plurality of internal and/or external storage devices. Companion device 300 is an example a device configured to receive a content information communication message. Companion device 300 may include one or more applications running thereon that may utilize information included in a content information communication message. Companion device 300 may be equipped for wired and/or wireless communications and may include devices, such as, for example, desktop or laptop computers, mobile devices, smartphones, cellular telephones, personal data assistants (PDA), tablet devices, and personal gaming devices.

As illustrated in FIG. 12, companion device 300 includes central processing unit(s) 302, system memory 304, system interface 310, storage device(s) 312, I/O device(s) 314, and network interface 316. As illustrated in FIG. 12, system memory 304 includes operating system 306 and applications 308. It should be noted that although example companion device 300 is illustrated as having distinct functional blocks, such an illustration is for descriptive purposes and does not limit companion device 300 to a particular hardware or software architecture. Functions of companion device 300 may be realized using any combination of hardware, firmware and/or software implementations.

Each of central processing unit(s) 302, system memory 304, and system interface 310, may be similar to central processoring unit(s) 202, system memory 204, and system interface 210 described above. Storage device(s) 312 represent memory of companion device 300 that may be configured to store larger amounts of data than system memory 304. For example, storage device(s) 312 may be configured to store a user's multimedia collection. Similar to system memory 304, storage device(s) 312 may also include one or more non-transitory or tangible computer-readable storage media. Storage device(s) 312 may be internal or external memory and in some examples may include non-volatile storage elements. Storage device(s) 312 may include memory cards (e.g., a Secure Digital (SD) memory card, including StandardCapacity (SDSC), High-Capacity (SDHC), and eXtended-Capacity (SDXC) formats), external hard disk drives, and/or an external solid state drive.

I/O device(s) 314 may be configured to receive input and provide output for companion device 300. Input may be generated from an input device, such as, for example, touch-sensitive screen, track pad, track point, mouse, a keyboard, a microphone, video camera, or any other type of device configured to receive input. Output may be provided to output devices, such as, for example, speakers or a display device. In some examples, I/O device(s) 314 may be external to companion device 300 and may be operatively coupled to companion device 300 using a standardized communication protocol, such as for example, Universal Serial Bus (USB) protocol.

Network interface 316 may be configured to enable companion device 300 to communicate with external computing devices, such as primary device 200 and other devices or servers. Further, in the example where companion device 300 includes a smartphone, network interface 316 may be configured to enable companion device 300 to communicate with a cellular network. Network interface 316 may include a network interface card, such as an Ethernet card, an optical transceiver, a radio frequency transceiver, or any other type of device that can send and receive information. Network interface 316 may be configured to operate according to one or more communication protocols such as, for example, a GSM standard, a CDMA standard, a 3GPP standard, an IP standard, a WAP standard, Bluetooth, ZigBee, and/or an IEEE standard, such as, one or more of the 802.11 standards, as well as various combinations thereof.

As illustrated in FIG. 3, system memory 304 includes operating system 306 and applications 308 stored thereon. Operating system 306 may be configured to facilitate the interaction of applications 308 with central processing unit(s) 302, and other hardware components of companion device 300. Operating system 306 may be an operating system designed to be installed on laptops and desktops. For example, operating system 306 may be a Windows (a registered trademark) operating system, Linux, or Mac OS. Operating system 306 may be an operating system designed to be installed smartphones, tablets, and/or gaming devices. For example, operating system 306 may be an Android, iOS, WebOS, Windows Mobile (a registered trademark), or a Windows Phone (a registered trademark) operating system. It should be noted that the techniques described herein are not limited to a particular operating system.

Applications 308 may be any applications implemented within or executed by companion device 300 and may be implemented or contained within, operable by, executed by, and/or be operatively/communicatively coupled to components of companion device 300. Applications 308 may include instructions that may cause central processing unit(s) 302 of companion device 300 to perform particular functions. Applications 308 may include algorithms which are expressed in computer programming statements, such as, for loops, while-loops, if-statements, do-loops, etc. Further, applications 308 may include second screen applications. As described above, a primary device may be configured to compose a content information communication message including one or more of the elements described in Table 1, Table 2, Table 3, and/or Table 4. Companion device 300 and/or applications 308 may be configured receive a content information message (e.g., a content message formatted according to any of the schemas described above) and parse content information for use in a second screen application.

Companion device 300 and/or applications 308 may be configured to receive content information communication messages according to one or more communications techniques. In one example, a content information communication message may be transmitted from a primary device, e.g., primary device 200, to a companion device, e.g., companion device 300, under one or more of the following conditions: (1) a primary device may send a content information communication message to a companion device as a subscription notification message; and/or (2) a primary device may send a content information communication message to a companion device as a response message based on a request from companion device.

FIG. 13 illustrates an example of a communications flow where a primary device sends a content information communication message to a companion device as a subscription notification message. In one example, a companion device may be subscribed to receive content information for the show currently being rendered on a primary device. In this example, a primary device may then send a notification message including content information to a companion device anytime the show information changes. As illustrated in FIG. 13, primary device 200 and companion device 300 perform subscription notification enrollment. In one example, a subscription enrollment process may occur as part of a discovery process. For example, when primary device 200 becomes connected to a home network, primary device 200 may broadcast or multicast a discovery message. Upon receiving a discovery message, companion device 300 may request a description of services from primary device 200. Upon receiving a description of services (e.g., an indication primary device supports subscription notifications), companion device 300 may enroll in subscription notifications.

As illustrated in FIG. 13, primary device 200 receives content information from television service provider site 106 or the web service provider site 118. As described above, primary device 200 may receive content information by extracting tables from a transport stream and/or by using one or more of NRT techniques and/or ESG techniques. As illustrated in FIG. 13, a notification event may occur at primary device 200. For example, a user may perform a channel change operation or a segment change may occur (e.g., a transition from a main program to a commercial). Upon a notification event occurring, primary device 200 sends a content information communication message to companion device 300. A content information communication message may include any of the content information communication messages described above. Upon receiving a content information communication message, a second screen application running on companion device 300 may utilize the received content information.

FIG. 14 illustrates an example of a communications flow where a primary device sends a content information communication message to a companion device as a request response message. As illustrated in FIG. 14, primary device 200 receives content information from a television service provider site 106 or the web service provider site 118. As illustrated in FIG. 14, companion device 300 requests content information. In one example, companion device 300 may be configured to request content information at regular intervals (e.g., every 10 seconds). Upon a receiving the request, primary device 200 sends a content information communication message to companion device 300. Upon receiving a content information communication message, a second screen application running on companion device 300 may utilize the received content information.

In addition to communicating using the techniques described with respect to FIGS. 13 and 14, primary device 200 and companion device 300 may be configured to communicate content information according to other techniques. In one example, a WebSocket mechanism may be used for communicating content communication information messages between primary device 200 and companion device 300. Additionally, Hybrid broadcast broadband TV (HbbTV) defined mechanisms (e.g. HbbTV 2.0 companion screen mechanisms) may be used for communicating content communication information messages between primary device 200 and companion device 300. In this case, in one example, the communication between primary device 200 and companion device 300 may be carried out as “application to application communication” as defined in HbbTV (e.g., applications 208 to applications 308).

In one example, a Universal Plug and Play (UPnP) Service may be defined for some or all of the content information message exchanges between primary device 200 and companion device 300. This may allow any UPnP control point to discover the UPnP content information communication message service. In this case, the content information may be transmitted from primary device 200 to companion device 300 via a UPnP control mechanism and/or via a UPnP eventing mechanism. In another example, a REST mechanism may be used for exchanging content information messages between primary device 200 and companion device 300. In this case, the content information may be transmitted from a primary device 200 to a companion device 300 via a HTTP GET mechanism and/or via a HTTP POST and/or via a HTTP PUT mechanism. In yet another example, SOAP may be used for exchanging content information messages between primary device 200 and companion device 300. In another example, primary device 200 may use the HTTP response body to send content information to companion device 300. When the HTTP response body is used content information may be in a format, such as, for example XML, CSV, BNF, ABNF, or EBNF.

In this manner, primary device 200 represents an example of a device configured to receive content information from a source, generate a content information communication message based on received content information, and transmit the content information communication message to a companion device. Further, in this manner, companion device 300 represents an example of a device configured to receive a content information communication message, and parse the content information communication message.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1. A method of transmitting content information to a companion device, the method comprising:
receiving a service guide from a source;
generating a content information communication message by encapsulating one or more elements according to schema, wherein the one or more elements correspond to a defined fragment in the service guide; and
transmitting the content information communication message to a companion device.

2. The method of claim 1, wherein the number of elements corresponding to defined fragments in the service guide is less than all of the defined fragments for the service guide.

3. The method of claim 2, wherein elements include service, content, and schedule fragments.

4. The method of claim 1, wherein transmitting the content information communication message to the companion device includes transmitting the content information communication message to the companion device as a response message based on a request from the companion device.

5. The method of claim 4, wherein transmitting the content information communication message to a companion device includes using a Hypertext Transport Protocol (HTTP) response body.

6. The method of claim 5, wherein a schema includes a JavaScript Object Notation (JSON) based schema.

7. The method of claim 1, wherein elements included in the content information communication message include a service guide response type element and elements corresponding to service, content, and schedule fragments.

8. The method of claim 7, wherein the service guide response type element indicates one of the following response types: a type indicating service guide information for a current show, a type indicating service guide information for a current service, and a type indicating service guide information service guide for all available services.

9. A device for transmitting content information, the device comprising one or more processors configured to:
receive a service guide from a source;
generate a content information communication message by encapsulating one or more elements according to schema, wherein the one or more elements correspond to a defined fragment in the service guide; and
transmit the content information communication message to a companion device.

10. The device of claim 9, wherein the number of elements corresponding to defined fragments in the service guide is less than all of the defined fragments for the service guide.

11. The device of claim 10, wherein elements include service, content, and schedule fragments.

12. The device of claim 10, wherein transmitting the content information communication message to the companion device includes transmitting the content information communication message to the companion device as a response message based on a request from the companion device.

13. The device of claim 12, wherein transmitting the content information communication message to a companion device includes using a Hypertext Transport Protocol (HTTP) response body.

14. The device of claim 13, wherein a schema includes a JavaScript Object Notation (JSON) based schema.

15. The device of claim 10, wherein elements included in the content information communication message include a service guide response type element and elements corresponding to service, content, and schedule fragments.

16. The device of claim 15, wherein the service guide response type indicates one of the following response types: a type indicating service guide information for a current show, a type indicating service guide information for a current service, and a type indicating service guide information for all available services.

17. A device for parsing content information, the device comprising one or more processors configured to:
receive a content information communication message including elements corresponding to service, content, and schedule fragments in a service guide;
parse the content information communication message; and
run a second screen application based on the parsed content information.

18. The device of claim 17, wherein the content information message includes service, content, and schedule fragments for one of: a current show, a current service, or all available services.

19. The device of claim 18, further comprising sending a request for service, content, and schedule fragments.

20. The device of claim 19, wherein sending a request includes sending a request including a query parameter, wherein the query parameter indicates a request for service, content, and schedule fragments for one of: a current show, a current service, or all available services.
